(19) United States
(12) Patent Application Publication
(10) Pub. No.: US 2026/0164122 A1
(43) Pub. Date: Jun. 11, 2026

(54) COMMUNICATION APPARATUS, CONTROL METHOD, AND STORAGE MEDIUM

(71) Applicant: CANON KABUSHIKI KAISHA, Tokyo (JP)

(72) Inventor: EIKO HIROSE, Tokyo (JP)

(21) Appl. No.: 19/181,435

(22) Filed: Apr. 17, 2025

(30) Foreign Application Priority Data
Apr. 22, 2024 (JP) 2024-069198

(51) Int. Cl. H04N 23/667; H04N 23/62

(52) U.S. Cl. CPC H04N 23/667; H04N 23/62

(57) ABSTRACT

There is provided a communication apparatus configured to communicate with an image capturing apparatus capable of executing a first recording operation. In a case where an operation mode of the communication apparatus is a first operation mode, a control unit executes obtainment control in which each time a new moving image file is generated in the image capturing apparatus, the new moving image file is obtained from the image capturing apparatus. In a case where the operation mode is a second operation mode, the control unit skips executing the obtainment control. A detection unit detects the image capturing apparatus starting the first recording operation. A switching unit switches the operation mode to the first operation mode in response to a start of the first recording operation being detected while the operation mode is the second operation mode.

### BACKGROUND OF THE INVENTION

### Field of the Invention

The present invention relates to a communication apparatus, a control method, and a storage medium.

### Description of the Related Art

A technique is known in which an image capturing apparatus such as a digital video camera is provided with a wireless communication function, generates moving image files recorded by dividing a moving image input from an image capturing apparatus into parts corresponding to each of predetermined lengths of time, and sends the moving image files to an external apparatus (Japanese Patent Laid-Open No. 2022-96304). Using this technology makes it possible to send moving images to the external apparatus more efficiently. Such divided recording of a moving image is called “chunk recording”.

In recent years, at sites in the mass media industry where images are shot, such as news companies and telecommunication companies, it is necessary to quickly deliver the shot content to the news company or the like. Various file transfer solutions which use network communication are therefore being used.

A mobile application running on a mobile portable terminal such as a smartphone, for obtaining image/moving image/audio files shot and recorded by an image capturing apparatus, is known as one example of such a solution. The mobile application sends the obtained files to an external File Transfer Protocol (FTP) server over a network.

Such a mobile application has what will be called a “shooting/automatic transfer function”, in which when a recording complete notification for a moving image file is received from an image capturing apparatus using, for example, the PTP/IP protocol, a series of processing for obtaining the moving image file from the image capturing apparatus and transferring that file to an external FTP server is executed automatically. By activating the shooting/automatic transfer function, a user can automatically deliver a moving image to an external destination without performing operations for selecting files obtained by shooting.

A plurality of moving image files generated through chunk recording (called “chunk moving image files” hereinafter) are typically combined at the destination and handled as a single moving image. Accordingly, it is necessary for all of the series of files, from the starting chunk moving image file to the ending chunk moving image file, to be present at the time of delivery. If the chunk moving image files are delivered with some of the files missing, a problem will arise in that the files cannot be combined correctly at the destination.

Consider a case where the shooting/automatic transfer function of the mobile application is activated after at least one recording complete notification, corresponding to at least one chunk moving image file including the first chunk moving image file, is sent by the image capturing apparatus. In this case, the mobile application cannot obtain the at least one chunk moving image file corresponding to the at least one recording complete notification sent before the shooting/automatic transfer function was activated. If a chunk moving image file obtained after the shooting/automatic transfer function was activated is sent to the destination, the previous chunk moving image files required for the combination will be missing at the destination.

### SUMMARY OF THE INVENTION

Having been achieved in light of such circumstances, the present invention provides a technique that, when an image capturing apparatus divides a moving image into a plurality of moving image files and records the files, reduces the likelihood of a communication apparatus obtaining only some of the plurality of moving image files from the image capturing apparatus.

According to a first aspect of the present invention, there is provided a communication apparatus configured to communicate with an image capturing apparatus capable of executing a first recording operation in which a moving image is divided into a plurality of moving image files and recorded, the communication apparatus comprising: a control unit configured to, in a case where an operation mode of the communication apparatus is a first operation mode, execute obtainment control in which each time a new moving image file is generated in the image capturing apparatus, the new moving image file is obtained from the image capturing apparatus, and in a case where the operation mode is a second operation mode, skip executing the obtainment control; a detection unit configured to detect the image capturing apparatus starting the first recording operation; and a switching unit configured to switch the operation mode to the first operation mode in response to a start of the first recording operation being detected while the operation mode is the second operation mode.

According to a second aspect of the present invention, there is provided a control method executed by a communication apparatus configured to communicate with an image capturing apparatus capable of executing a first recording operation in which a moving image is divided into a plurality of moving image files and recorded, the control method comprising: in a case where an operation mode of the communication apparatus is a first operation mode, executing obtainment control in which each time a new moving image file is generated in the image capturing apparatus, the new moving image file is obtained from the image capturing apparatus, and in a case where the operation mode is a second operation mode, skipping executing the obtainment control; detecting the image capturing apparatus starting the first recording operation; and switching the operation mode to the first operation mode in response to a start of the first recording operation being detected while the operation mode is the second operation mode.

According to a third aspect of the present invention, there is provided a non-transitory computer-readable storage medium which stores a program for causing a computer of a communication apparatus to execute a control method, the communication apparatus being configured to communicate with an image capturing apparatus capable of executing a first recording operation in which a moving image is divided into a plurality of moving image files and recorded, the control method comprising: in a case where an operation mode of the communication apparatus is a first operation mode, executing obtainment control in which each time a new moving image file is generated in the image capturing apparatus, the new moving image file is obtained from the image capturing apparatus, and in a case where the operation mode is a second operation mode, skipping executing the obtainment control; detecting the image capturing apparatus starting the first recording operation; and switching the operation mode to the first operation mode in response to a start of the first recording operation being detected while the operation mode is the second operation mode.

Further features of the present invention will become apparent from the following description of exemplary embodiments with reference to the attached drawings.

### BRIEF DESCRIPTION OF THE DRAWINGS

FIG. 1 is a schematic diagram illustrating the configuration of a communication system.

FIG. 2A is a block diagram illustrating an example of the configuration of an image capturing apparatus 100.

FIG. 2B is a diagram illustrating an example of the external appearance of the image capturing apparatus 100.

FIG. 3 is a block diagram illustrating an example of the configuration of a communication apparatus 200.

FIG. 4A is a diagram illustrating two methods by which the image capturing apparatus 100 stores a moving image file for transfer, which is in MP4 file format, into a storage medium 110.

FIG. 4B is a diagram illustrating time required from the start of recording to the completion of transfer of a moving image file, for each of proxy recording and chunk recording.

FIGS. 5A to 5D are diagrams illustrating a user interface (screens displayed in a display unit 206) of a transfer app executed by the communication apparatus 200.

FIG. 6A is a diagram illustrating a sequence of processing performed in shooting automatic transfer in the case of proxy recording.

FIGS. 6B-1 and 6B-2 are diagrams illustrating a sequence of processing performed in shooting automatic transfer in the case of chunk recording.

FIG. 7A is a flowchart illustrating shooting automatic transfer processing that involves automatically switching an operation mode.

FIG. 7B is a flowchart illustrating a variation on the processing illustrated in FIG. 7A.

FIG. 8 is a diagram illustrating a sequence of processing performed in shooting automatic transfer when the communication apparatus 200 performs the processing illustrated in FIG. 7A.

FIGS. 9A and 9B are diagrams illustrating an example of screens for causing a user to select whether to switch the operation mode to an “automatic transfer on” mode.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### Configuration of Communication System

FIG. 1 is a schematic diagram illustrating the configuration of a communication system. In FIGS. 1, 100 indicates an image capturing apparatus such as a digital video camera. 200 indicates a communication apparatus such as a mobile terminal. The communication apparatus 200 is an information processing apparatus having a communication function, such as a smartphone or a computer. 300 is a server. The server 300 is an image storage apparatus, which can be installed at a connection destination connected over a communication network such as the Internet.

In FIG. 1, the image capturing apparatus 100 and the communication apparatus 200 are connected by wired communication using a cable, or by wireless communication using technology such as Wi-Fi. The image capturing apparatus 100 can transfer a generated moving image file to the communication apparatus 200. The communication apparatus 200 and the server 300 are connected using communication technology such as mobile data communication. The communication apparatus 200 is capable of transferring information stored in the communication apparatus 200 to the server 300 according to a communication protocol such as FTP.

Note that the configuration of the communication system is not limited to the configuration described above. For example, a configuration may be employed in which the image capturing apparatus 100, the communication apparatus 200, and the server 300 are connected to the same network via access points, rather than using mobile data communication.

### Configuration of Image Capturing Apparatus 100

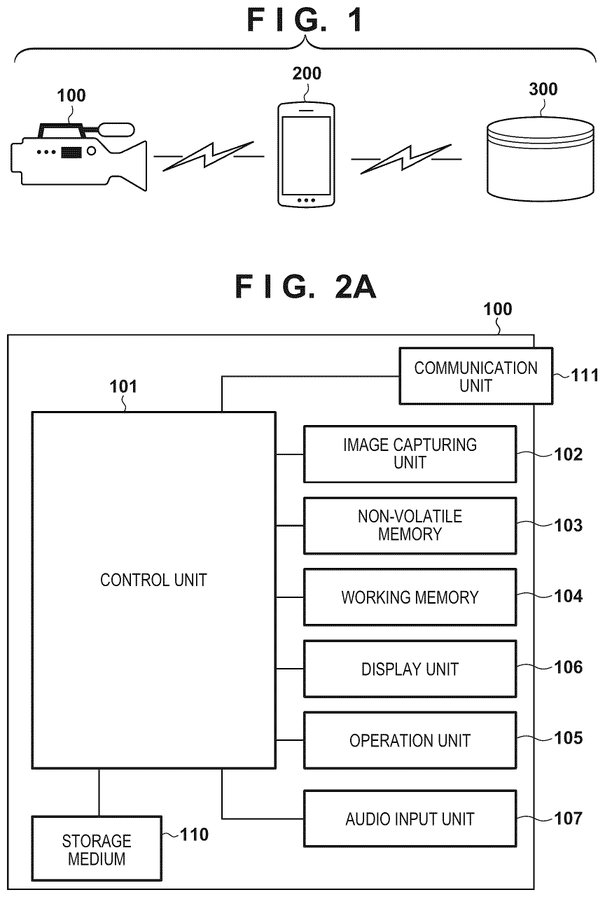

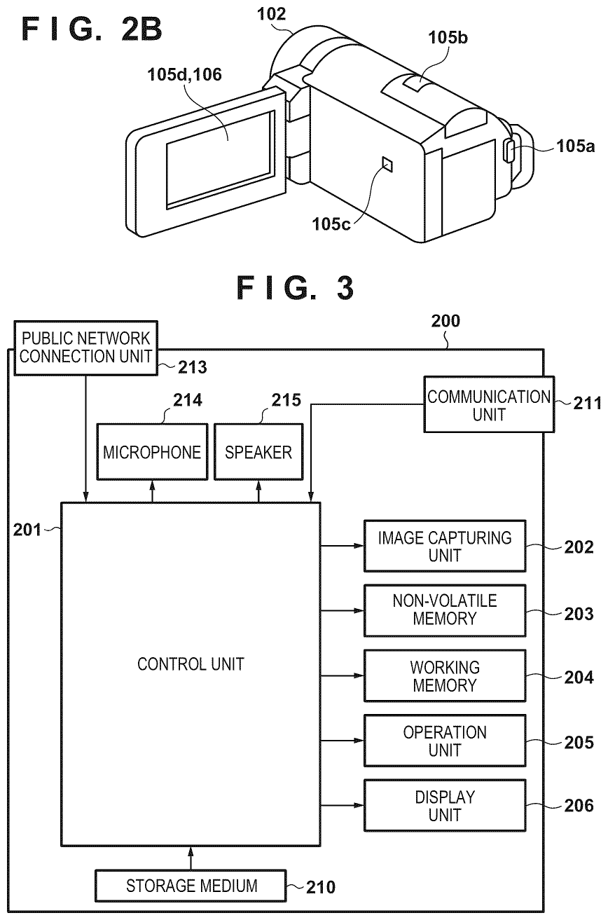

FIG. 2A is a block diagram illustrating an example of the configuration of the image capturing apparatus 100. Although a digital video camera is described here as an example of the image capturing apparatus 100, the image capturing apparatus 100 is not limited to a digital video camera. The image capturing apparatus 100 may be any information processing apparatus, such as a portable media player, what is known as a “tablet device”, a personal computer, or the like, for example.

A control unit 101 controls the various units of the image capturing apparatus 100 in accordance with input signals, programs (described later), and the like. Note that rather than the control unit 101 controlling the image capturing apparatus 100 as a whole, a plurality of pieces of hardware may control the image capturing apparatus 100 as a whole by distributing processing among the hardware.

An image capturing unit 102 includes, for example, an optical lens unit including an aperture mechanism, a zoom lens, and a focus lens, and an image sensor for converting light entering through the optical lens unit into an electrical image signal. A Complementary Metal Oxide Semiconductor (CMOS) or a Charge Coupled Device (CCD) is used as the image sensor, for example. Under the control of the control unit 101, the image capturing unit 102 uses the image sensor to convert subject light, formed into an image by a lens included in the image capturing unit 102, into an electrical signal. The image capturing unit 102 performs noise reduction processing and the like on the electrical signal, and outputs digital data corresponding to the electrical signal as moving image data. The moving image data is stored into a storage medium 110.

A non-volatile memory 103 is a non-volatile memory that can be electrically erased and recorded to, and stores programs and the like that are executed by the control unit 101.

A working memory 104 is used as a buffer memory that temporarily stores the moving image data captured by the image capturing unit 102, moving image display memory for a display unit 106, a work region for the control unit 101, and the like.

An operation unit 105 is used for accepting instructions made to the image capturing apparatus 100 by a user. For example, the operation unit 105 includes a power button through which the user instructs the power of the image capturing apparatus 100 to be turned on and off, a release switch for instructing the start/stop of shooting, a playback button for instructing the playback of moving image data, and the like. The operation unit 105 also includes operation members such as a “connect” button for starting communication with an external device via a communication unit 111 (described later). The operation unit 105 also includes a touch panel formed on the display unit 106 (described later).

The display unit 106 displays a viewfinder image at the time of shooting, shot moving image data, text for interactive operations, and the like. Note that the display unit 106 does not absolutely need to be built into the image capturing apparatus 100. It is sufficient for the image capturing apparatus 100 to be capable of connecting to an internal or external display unit 106 and have at least a display control function for controlling the display in the display unit 106.

An audio input unit 107 is a device for inputting audio. The audio input unit 107 generates audio data on the basis of the input audio. Audio data is stored into the storage medium 110 in an audio file format.

The storage medium 110 can store the moving image data output from the image capturing unit 102 and the audio data output from the audio input unit 107. The image capturing apparatus 100 includes two slots for inserting the storage medium 110. The control unit 101 stores a high-resolution moving image file (called a “main moving image file” hereinafter) into the storage medium 110 in the first slot. The resolution of the main moving image file is, for example, a recording resolution specified by the user (e.g., the highest resolution of the image sensor in the image capturing unit 102). The control unit 101 can generate a low-resolution or low-bitrate moving image file (called a “proxy moving image file” hereinafter), or a chunk moving image file for chunk recording, for sending from the communication unit 111 to the communication apparatus 200 over the network. The control unit 101 can store the generated proxy moving image file or chunk moving image file into the storage medium 110 in the second slot.

Note that the number of slots provided in the image capturing apparatus 100 may be one, or may be three or more. In addition, the storage medium 110 may be built into the image capturing apparatus 100. Even in this case, however, the number of the storage medium 110 is not particularly limited. In other words, it is sufficient for the image capturing apparatus 100 to have a function for accessing at least one storage medium 110.

The communication unit 111 is an interface for communicating with an external apparatus. The image capturing apparatus 100 can exchange data with the external apparatus through the communication unit 111. For example, the image capturing apparatus 100 can send the moving image data generated by the image capturing unit 102 and the audio data generated by the audio input unit 107 to the external apparatus through the communication unit 111. In the present embodiment, the communication unit 111 includes an interface for communicating through what is known as “wireless LAN”, based on the IEEE 802.11 standard.

The communication unit 111 also includes a Universal Serial Bus (USB) interface for communicating with the external apparatus over a USB cable. The control unit 101 implements wireless and wired communication with the external apparatus by controlling the communication unit 111.

Note that the communication unit 111 has an access point mode (“AP mode” hereinafter) for operating as an access point in infrastructure mode. The communication unit 111 also has a client mode (“CL mode” hereinafter) for operating as a client in infrastructure mode. By operating the communication unit 111 in CL mode, the image capturing apparatus 100 can operate as a CL device in infrastructure mode. When the image capturing apparatus 100 operates as a CL device, the image capturing apparatus 100 can join a network formed by a nearby AP device by connecting to the AP device. In addition, by operating the communication unit 111 in AP mode, the image capturing apparatus 100 can operate as a simplified AP (“simple AP” hereinafter) which is a kind of AP, but has limited functions. When the image capturing apparatus 100 operates as a simple AP, the image capturing apparatus 100 forms a network itself. An apparatus in the vicinity of the image capturing apparatus 100 can recognize the image capturing apparatus 100 as an AP device and join the network formed by the image capturing apparatus 100. A program for causing the image capturing apparatus 100 to function as described above is held in the non-volatile memory 103.

Note that while being a kind of AP, the simple AP does not have a gateway function for transferring data received from a CL device to an Internet provider or the like. Accordingly, even if the image capturing apparatus 100 operating as a simple AP receives data from another apparatus that has joined the network formed by the image capturing apparatus 100, that data cannot be transferred to a network such as the Internet.

Next, the appearance of the image capturing apparatus 100 will be described with reference to FIG. 2B. FIG. 2B is a diagram illustrating an example of the external appearance of the image capturing apparatus 100. A release switch 105a, a zoom lever 105b, a playback button 105c, and a touch panel 105d are operation members included in the operation unit 105 described above. Moving images obtained as a result of the capturing by the image capturing unit 102 are also displayed in the display unit 106.

### Configuration of Communication Apparatus 200

FIG. 3 is a block diagram illustrating an example of the configuration of the communication apparatus 200. A portable mobile terminal will be described as an example of the communication apparatus 200 here, but it should be noted that the communication apparatus 200 is not limited to a portable mobile terminal. The communication apparatus 200 may be a digital video camera having wireless functionality, a tablet device, a personal computer, or the like, for example.

A control unit 201 controls the various units of the communication apparatus 200 in accordance with input signals, programs (described later), and the like. Note that rather than the control unit 201 controlling the communication apparatus 200 as a whole, a plurality of pieces of hardware may control the communication apparatus 200 as a whole by distributing processing among the hardware.

An image capturing unit 202 converts subject light, formed as an image by a lens included in the image capturing unit 202, into an electrical signal, performs noise reduction processing and the like on the electrical signal, and outputs digital data corresponding to the electrical signal as moving image data. The captured moving image data is stored in a buffer memory. The control unit 201 then performs predetermined computations on the moving image data, and stores the result thereof into a storage medium 210.

A non-volatile memory 203 is a non-volatile memory that can be electrically erased and recorded to. Programs and the like executed by the control unit 201 are stored in the non-volatile memory 203. An operating system (OS), which is basic software executed by the control unit 201, applications that implement practical functions by operating cooperatively with the OS, and the like are examples of the programs recorded in the non-volatile memory 203.

In the present embodiment, a transfer application (called “transfer app”, hereinafter) for the communication apparatus 200 to communicate with the image capturing apparatus 100 and the server 300 is also stored in the non-volatile memory 203. Additionally, a file management application (called “file management app” hereinafter) and image management application (called “image management app” hereinafter), which manage the moving image files and audio files output from the image capturing apparatus 100, are stored in the non-volatile memory 203.

A working memory 204 is used as an image display memory for a display unit 206, a work region for the control unit 201, a buffer memory, and the like. In the present embodiment, when the communication apparatus 200 transfers a moving image file received from the image capturing apparatus 100 to the server 300, the moving image file is stored in the working memory 204 temporarily.

An operation unit 205 is used for accepting instructions made to the communication apparatus 200 by a user. The operation unit 205 includes operation members such as, for example, a power button through which the user instructs the power of the communication apparatus 200 to be turned on and off, a touch panel formed on the display unit 206, and the like.

The display unit 206 displays moving image data, a text display for interactive operations, and the like. Note that the communication apparatus 200 does not absolutely need to include the display unit 206. It is sufficient for the communication apparatus 200 to be capable of connecting to the display unit 206 and have at least a display control function for controlling the display in the display unit 206.

The storage medium 210 can store moving image data output from the image capturing unit 202. The storage medium 210 may be configured to be removable from the communication apparatus 200, or may be built into the communication apparatus 200. In other words, it is sufficient for the communication apparatus 200 to have a function for accessing at least the storage medium 210.

A communication unit 211 is an interface for communicating with an external apparatus. The communication apparatus 200 can exchange data with the image capturing apparatus 100 and the server 300 through the communication unit 211. The communication unit 211 includes an antenna. The control unit 201 can connect to the image capturing apparatus 100 using the antenna. Note that the communication apparatus 200 may connect to the image capturing apparatus 100 and the server 300 directly, or via an access point. Picture Transfer Protocol over Internet Protocol (PTP/IP) through wireless LAN, for example, can be used as the protocol for communicating data.

The communication unit 211 also includes a Universal Serial Bus (USB) interface for communicating with the external apparatus over a USB cable.

Note that the method for communicating with the external apparatus is not limited to the method described above. For example, the communication unit 211 may include an infrared communication module, a Bluetooth (registered trademark) communication module, a wireless communication module such as wireless USB, or the like.

A public network connection unit 213 is an interface used when performing public wireless line communication. The communication apparatus 200 can make voice calls with other devices through the public network connection unit 213. At this time, the voice calls are implemented by the control unit 201 inputting and outputting audio signals via a microphone 214 and a speaker 215.

The communication apparatus 200 can exchange data with the server 300 through the public network connection unit 213 as well. The public network connection unit 213 includes an antenna. The control unit 201 can connect to a public network using the antenna. Note that the communication unit 211 and the public network connection unit 213 can also share a single antenna. Communication performed through the communication unit 211 is typically faster than communication performed over a public network. As such, in the communication apparatus 200 of the present embodiment, communication performed through the communication unit 211 is prioritized when a call is not being made.

### Proxy Recording and Chunk Recording

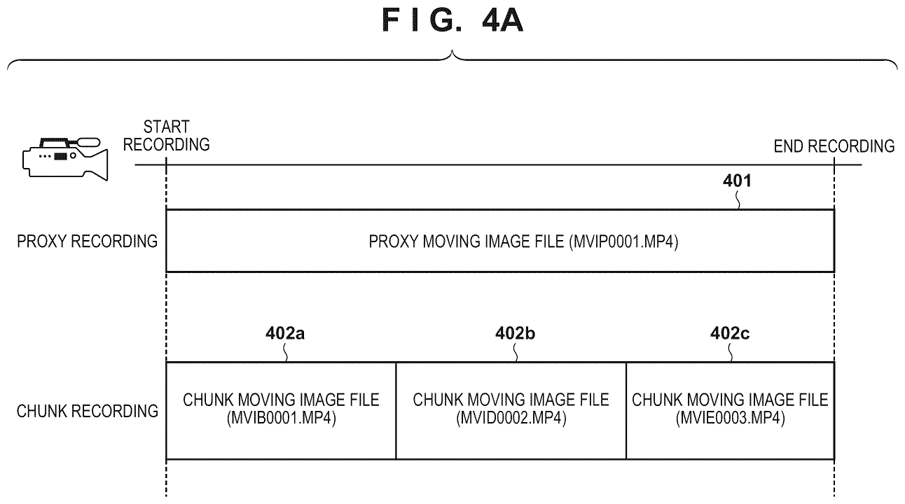

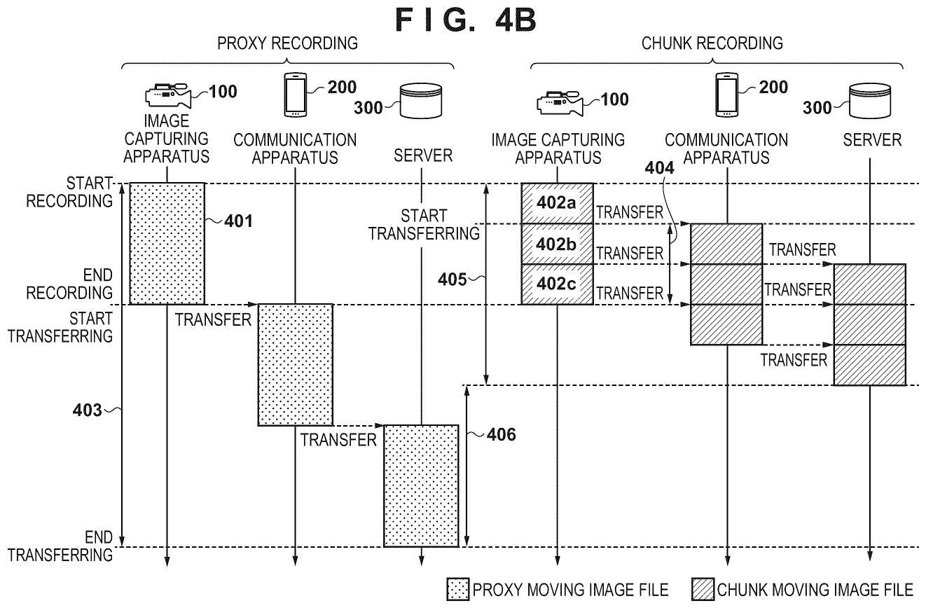

Two methods by which the image capturing apparatus 100 stores a moving image file for transfer, which is in MP4 file format, into the storage medium 110 will be described next with reference to FIG. 4A. The moving image file for transfer has a lower resolution than the main moving image file, a lower bitrate than the main moving image file, or both. Recording of a moving image starts when the user presses the release switch 105a of the image capturing apparatus 100, and ends when the release switch 105a is pressed again.

The first method is a method for recording a proxy moving image file having the same recording time as the main moving image file (called “proxy recording” hereinafter) as the moving image file for transfer. In FIGS. 4A, 401 indicates a proxy moving image file for which the time from the start to the end of recording is the recording time. In this manner, in proxy recording, a single proxy moving image file corresponding to the time from the start to the end of recording is generated.

In the present embodiment, the filename of the proxy moving image file 401 starts with “MVI”, with the fourth letter thereafter being “P”, followed by a file number and an extension, for example. For example, the filename is written as “MVIP0001.MP4”.

The second method is a method for recording a small proxy moving image file obtained through division each time a predetermined length of time passes while a moving image is being recorded (called “chunk recording” hereinafter) as the moving image file for transfer. In the present embodiment, each of the divided small proxy moving image files generated by chunk recording is used as a chunk moving image file. For example, a new chunk moving image file is generated when 30 seconds have passed from the start of recording or from the timing at which the previous chunk moving image file was generated. In FIG. 4A, the control unit 201 generates a chunk moving image file 402a when 30 seconds have passed following the start of recording. The control unit 201 then generates a chunk moving image file 402b when 30 seconds have passed following the generation of the chunk moving image file 402a. When the user presses the release switch 105a before 30 seconds have passed following the generation of the chunk moving image file 402b, the control unit 201 stops the recording of the moving image, and generates a chunk moving image file 402c corresponding to the time from when the chunk moving image file 402b was generated to when the recording was stopped.

In the present embodiment, the filenames of the chunk moving image files are determined as follows, for example. The filename of the chunk moving image file 402a generated first starts with “MVI”, and the fourth letter thereafter is “B”. The fourth letter being “B” indicates that the chunk moving image file 402a is the chunk moving image file at the beginning (at the start of the recording). The filename includes a file number and an extension after the “B”. The filename is therefore “MVIB0001.MP4”. The filename of the chunk moving image file 402b generated next starts with “MVI”, and the fourth letter thereafter is “D”. The fourth letter being “D” indicates that the chunk moving image file 402b is an intermediate chunk moving image file. The filename includes a file number and an extension after the “D”. The filename is therefore “MVID0002.MP4”. The filename of the chunk moving image file 402c generated last starts with “MVI”, and the fourth letter thereafter is “E”. The fourth letter being “E” indicates that the chunk moving image file 402c is the chunk moving image file at the end (at the end of the recording). The filename includes a file number and an extension after the “E”. The filename is therefore “MVIE0003.MP4”.

In this manner, a naming convention that changes the fourth letter of the filename is used in the present embodiment. Accordingly, the communication apparatus 200 can determine whether the current moving image recording is proxy recording or chunk recording by confirming the fourth letter of the moving image file. In the case of chunk recording, the communication apparatus 200 can determine whether each chunk moving image file is the file at the beginning, an intermediate file, or the file at the end.

Time required from the start of recording to the completion of transfer of a moving image file, for each of proxy recording and chunk recording, will be described next with reference to FIG. 4B.

In the case of proxy recording, the proxy moving image file is not completed while the moving image is being recorded. As such, the image capturing apparatus 100 cannot send the proxy moving image file while the moving image is being recorded. The image capturing apparatus 100 starts processing for sending (transferring) the proxy moving image file to the communication apparatus 200 after the recording of the proxy moving image file ends. The communication apparatus 200 starts processing for sending the received proxy moving image file to the server 300 after the completion of receiving the proxy moving image file. Accordingly, a time 403 from the start of proxy recording to the completion of the transfer of the proxy moving image file 401 includes the sending time of the proxy moving image file 401 in addition to the recording time of the proxy moving image file 401.

In the case of chunk recording, the image capturing apparatus 100 can send generated chunk moving image files in succession even while the moving image is being recorded. For example, once the chunk moving image file 402a has been generated, the image capturing apparatus 100 can start processing for transferring the chunk moving image file 402a, even while the moving image is being recorded. Accordingly, in the case of chunk recording, the image capturing apparatus 100 can start the transfer earlier than in the case of proxy recording by a time difference 404. As a result, compared to the time 403 in the case of proxy recording, a time 405 from the start of chunk recording to the completion of the transfer of the final chunk moving image file 402c is shorter by a time difference 406.

As described above, the image capturing apparatus 100 can selectively execute chunk recording (a first recording operation that divides a moving image into a plurality of moving image files and records the moving image files) or proxy recording (a second recording operation that records a moving image in a single moving image file) as the operations for recording moving images.

### User Interface of Transfer App

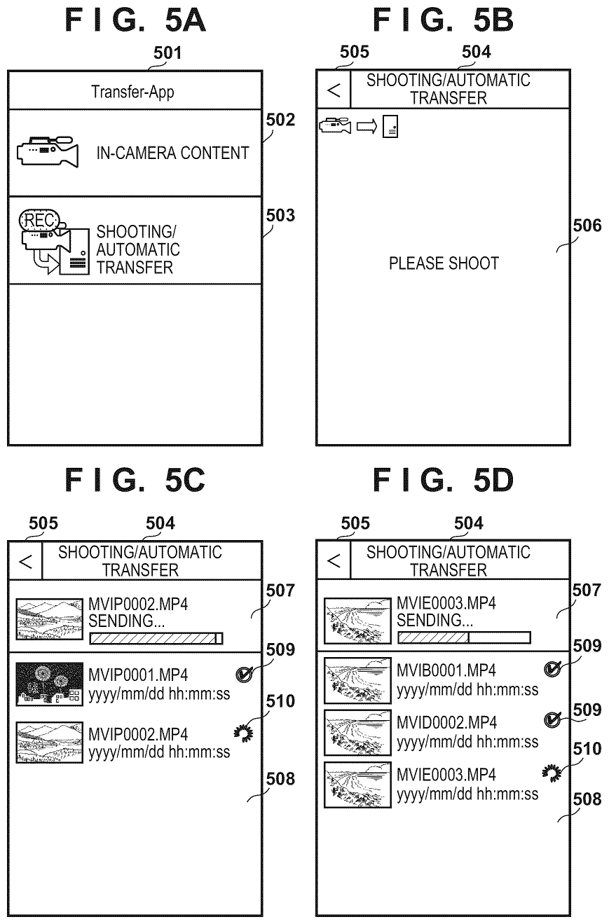

A user interface (screens displayed in the display unit 206) of the transfer app executed by the communication apparatus 200 will be described with reference to FIGS. 5A to 5D.

FIG. 5A illustrates a function selection screen 501. The function selection screen 501 is displayed while the communication apparatus 200 is connected to the image capturing apparatus 100 after the transfer app is launched. The function selection screen 501 includes an in-camera content list display button 502 and a shooting/automatic transfer button 503. When the user presses the in-camera content list display button 502, the screen of the transfer app transitions to an in-camera content list screen (not shown), which displays a list of files recorded in the image capturing apparatus 100. When the user presses the shooting/automatic transfer button 503, the screen of the transfer app transitions to a shooting/automatic transfer screen 504, illustrated in FIG. 5B.

The shooting/automatic transfer screen 504 is a screen for displaying files generated by the image capturing apparatus 100 and transferred to the server 300 via the communication apparatus 200. When the screen of the transfer app transitions to the shooting/automatic transfer screen 504, the communication apparatus 200 performs switching processing for switching the operation mode of the communication apparatus 200 from an “automatic transfer off” mode (a second operation mode) to the “automatic transfer on” mode (a first operation mode). In the “automatic transfer on” mode, the communication apparatus 200 accepts a moving image file generation notification from the image capturing apparatus 100 (also called simply a “generation notification” hereinafter). If, when the image capturing apparatus 100 sends a generation notification to the communication apparatus 200, the operation mode of the communication apparatus 200 is the “automatic transfer on” mode, the communication apparatus 200 accepts the generation notification and performs automatic transfer processing (various types of processing necessary for transferring a moving image file). If the communication apparatus 200 is in the “automatic transfer off” mode (if the screen of the transfer app has not transitioned to the shooting/automatic transfer screen 504), the communication apparatus 200 does not accept generation notifications, and discards any generation notifications even if they are received. The automatic transfer processing is not performed in this case.

Note that the following descriptions assume that the image capturing apparatus 100 sends a generation notification to the communication apparatus 200 each time a new moving image file is generated, regardless of whether or not the operation mode of the communication apparatus 200 is the “automatic transfer on” mode. However, a configuration may be employed in which the image capturing apparatus 100 does not send generation notifications while the operation mode of the communication apparatus 200 is the “automatic transfer off” mode. In this case, the communication apparatus 200 sends a generation notification start request to the image capturing apparatus 100 in response to the operation mode being switched to the “automatic transfer on” mode. The image capturing apparatus 100 detects that the operation mode of the communication apparatus 200 has been switched to the “automatic transfer on” mode in response to the generation notification start request being received, and enables the transmission of a generation notification. The communication apparatus 200 sends a generation notification stop request to the image capturing apparatus 100 in response to the operation mode being switched to the “automatic transfer off” mode. The image capturing apparatus 100 detects that the operation mode of the communication apparatus 200 has been switched to the “automatic transfer off” mode in response to the generation notification stop request being received, and disables the transmission of a generation notification.

The shooting/automatic transfer screen 504 includes a back button 505 for returning to the previous screen. Additionally, prior to the start of the file transfer, the shooting/automatic transfer screen 504 includes a display area 506 in which a message prompting shooting (“shoot an image”) is displayed.

When the user presses the back button 505, the screen of the transfer app transitions to the function selection screen 501. When the screen of the transfer app transitions to the function selection screen 501, the communication apparatus 200 performs switching processing for switching the operation mode of the communication apparatus 200 from the “automatic transfer on” mode (the first operation mode) to the “automatic transfer off” mode (the second operation mode). Accordingly, the communication apparatus 200 can switch the operation mode between the “automatic transfer on” mode and the “automatic transfer off” mode in accordance with a user instruction made using the shooting/automatic transfer button 503 or the back button 505.

When the file transfer is started, the shooting/automatic transfer screen 504 includes a display area 507 and a display area 508 instead of the display area 506, as illustrated in FIGS. 5C and 5D.

FIG. 5C illustrates an example of the display of the shooting/automatic transfer screen 504 when transferring a proxy moving image file. Information about the moving image file being transferred (here, a thumbnail image and a filename) is displayed in the display area 507. The information about the moving image file is included in the generation notification received from the image capturing apparatus 100, for example. A character string and a progress bar indicating the transfer progress are also displayed in the display area 507. Different character strings (“obtaining” or “sending”) are displayed as the character string indicating the transfer progress depending on whether the communication apparatus 200 is obtaining a moving image file from the image capturing apparatus 100 or sending a moving image file to the server 300. The progress bar also includes an area having a length that varies according to the amount of data of the moving image file already obtained from the image capturing apparatus 100 or the amount of data of the moving image file already sent to the server 300.

A list of information about moving image files transferred after the screen of the transfer app transitioned to the shooting/automatic transfer screen 504 (including moving image files currently being obtained or sent) is displayed in the display area 508. The information about each moving image file includes a thumbnail image, a filename, and a status icon indicating transfer progress.

An icon 509 indicating that the transfer is complete or an icon 510 indicating that the transfer is in progress is displayed as the status icon.

FIG. 5D illustrates an example of the display of the shooting/automatic transfer screen 504 when transferring a chunk moving image file. Aside from the moving image file being a chunk moving image file, the shooting/automatic transfer screen 504 illustrated in FIG. 5D has the same configuration as the shooting/automatic transfer screen 504 illustrated in FIG. 5C.

### Sequence of Processing in Shooting Automatic Transfer (Proxy Recording)

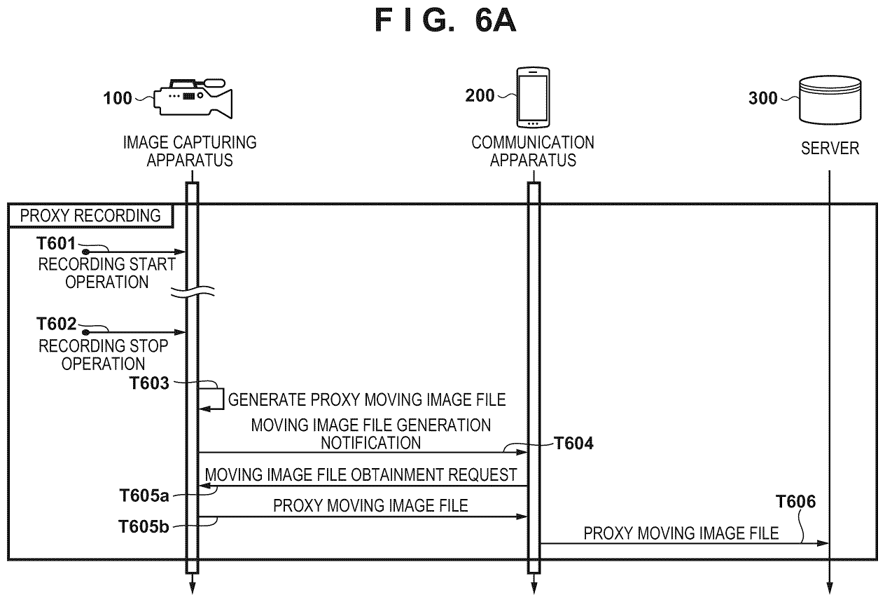

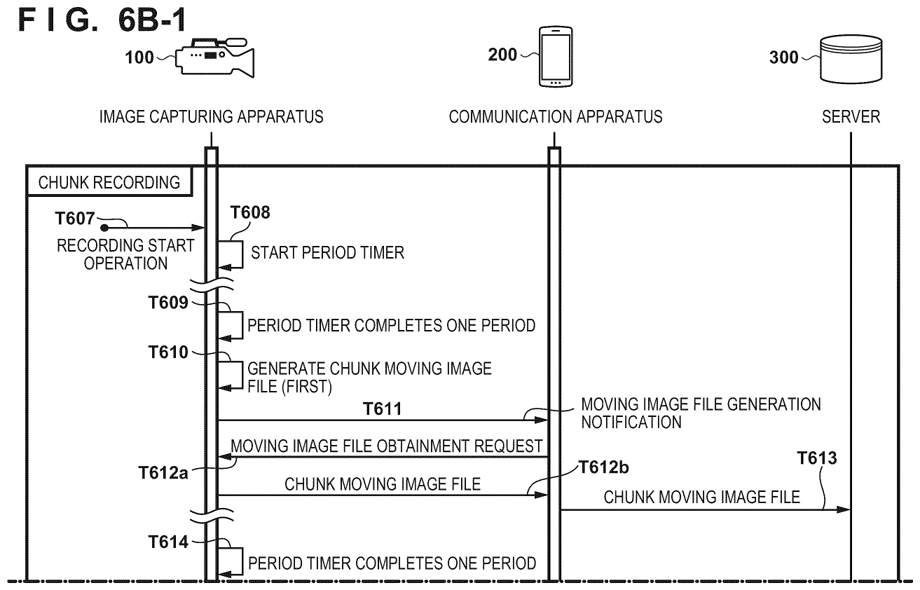

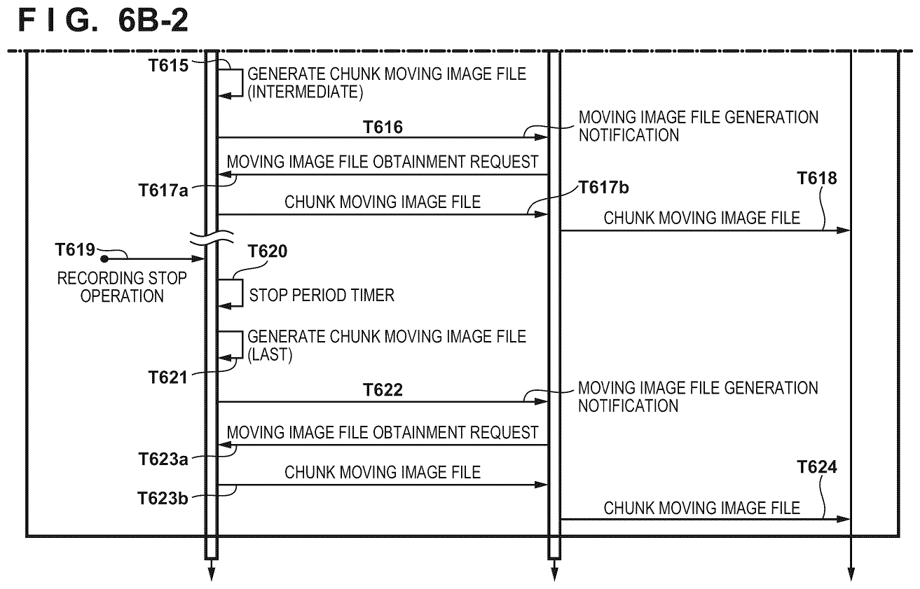

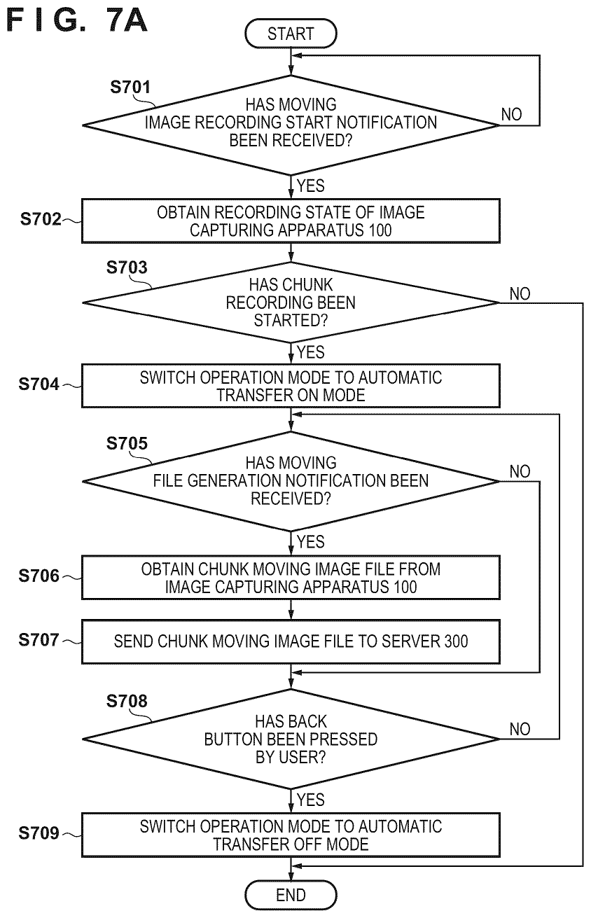

A sequence of processing performed in shooting automatic transfer in the case of proxy recording will be described with reference to FIG. 6A. It is assumed that prior to the start of the processing sequence, the screen of the transfer app of the communication apparatus 200 has transitioned to the shooting/automatic transfer screen 504. As such, the operation mode of the communication apparatus 200 is the “automatic transfer on” mode. It is also assumed that the recording mode of the image capturing apparatus 100 is set to a mode in which proxy recording is performed.

At time T601, the control unit 101 of the image capturing apparatus 100 receives a recording start operation from the user through the operation unit 105. When the recording start operation is received, the control unit 101 starts proxy recording (a second recording operation in which a moving image is recorded in a single moving image file).

At time T602, the control unit 101 receives a recording stop operation from the user through the operation unit 105. When the recording stop operation is received, the control unit 101 ends the proxy recording.

At time T603, the control unit 101 generates a proxy moving image file.

At time T604, the control unit 101 sends, to the communication apparatus 200, a generation notification indicating that the proxy moving image file has been generated. The control unit 201 of the communication apparatus 200 receives the generation notification from the image capturing apparatus 100.

At time T605a, the control unit 201 of the communication apparatus 200 sends a moving image file obtainment request to the image capturing apparatus 100. The control unit 101 of the image capturing apparatus 100 receives the moving image file obtainment request from the communication apparatus 200.

At time T605b, the control unit 101 of the image capturing apparatus 100 sends the proxy moving image file to the communication apparatus 200 as a response to the moving image file obtainment request. The control unit 201 of the communication apparatus 200 obtains (receives) the proxy moving image file from the image capturing apparatus 100.

At time T606, the control unit 201 of the communication apparatus 200 sends the proxy moving image file obtained from the image capturing apparatus 100 to the server 300. The server 300 receives the proxy moving image file from the communication apparatus 200.

A proxy moving image file recorded by the image capturing apparatus 100 can be transferred to the server 300 via the communication apparatus 200 through the series of processing described above.

### Sequence of Processing in Shooting Automatic Transfer (Chunk Recording)

A sequence of processing performed in shooting automatic transfer in the case of chunk recording will be described next with reference to FIGS. 6B-1 and 6B-2. It is assumed that prior to the start of the processing sequence, the screen of the transfer app of the communication apparatus 200 has transitioned to the shooting/automatic transfer screen 504. As such, the operation mode of the communication apparatus 200 is the “automatic transfer on” mode. It is also assumed that the recording mode of the image capturing apparatus 100 is set to a mode in which chunk recording is performed.

At time T607, the control unit 101 of the image capturing apparatus 100 receives a recording start operation from the user through the operation unit 105. When the recording start operation is received, the control unit 101 starts chunk recording (a first recording operation in which a moving image is divided into a plurality of moving image files and the moving image files are recorded).

At time T608, the control unit 101 starts a period timer. The period timer is used to periodically detect the passage of a predetermined length of time. The “predetermined length of time” here is, for example, a time specified in advance by the user, and corresponds to the recording time of a single chunk moving image file.

At time T609, the period timer completes one period.

At time T610, the control unit 101 generates a chunk moving image file. This chunk moving image file is the first chunk moving image file and therefore has a filename of “MVIB0001.MP4”.

At time T611, the control unit 101 sends, to the communication apparatus 200, a generation notification indicating that the chunk moving image file has been generated. The control unit 201 of the communication apparatus 200 receives the generation notification from the image capturing apparatus 100.

At time T612a, the control unit 201 of the communication apparatus 200 sends a moving image file obtainment request to the image capturing apparatus 100. The control unit 101 of the image capturing apparatus 100 receives the moving image file obtainment request from the communication apparatus 200.

At time T612b, the control unit 101 of the image capturing apparatus 100 sends the chunk moving image file to the communication apparatus 200 as a response to the moving image file obtainment request. The control unit 201 of the communication apparatus 200 obtains (receives) the chunk moving image file from the image capturing apparatus 100.

At time T613, the control unit 201 of the communication apparatus 200 sends the chunk moving image file obtained from the image capturing apparatus 100 to the server 300. The server 300 receives the chunk moving image file from the communication apparatus 200.

At time T614, the period timer completes one period.

At time T615, the control unit 101 of the image capturing apparatus 100 generates a chunk moving image file. This chunk moving image file is an intermediate chunk moving image file and therefore has a filename of “MVID0002.MP4”.

The processing at times T616, T617a, T617b, and T618 is the same as the processing at times T611, T612a, T612b, and T613.

At time T619, the control unit 101 of the image capturing apparatus 100 receives a recording stop operation from the user through the operation unit 105. When the recording stop operation is received, the control unit 101 ends the chunk recording.

At time T620, the control unit 101 stops the period timer.

At time T621, the control unit 101 generates a chunk moving image file. This chunk moving image file is the last chunk moving image file and therefore has a filename of “MVIE0003.MP4”.

The processing at times T622, T623a, T623b, and T624 is the same as the processing at times T611, T612a, T612b, and T613.

A series of chunk moving image files recorded by the image capturing apparatus 100 can be transferred to the server 300 via the communication apparatus 200 through the series of processing described above.

### Shooting Automatic Transfer Processing Involving Automatically Switching Operation Mode

The foregoing described, with reference to FIGS. 6B-1 and 6B-2, that prior to the start of the processing sequence, the screen of the transfer app of the communication apparatus 200 had transitioned to the shooting/automatic transfer screen 504, and the operation mode of the communication apparatus 200 had been switched to the “automatic transfer on” mode. However, it is possible for the user to perform a recording start operation in the image capturing apparatus 100 without performing an operation for transitioning to the shooting/automatic transfer screen 504 in the communication apparatus 200. In this case, the operation mode of the communication apparatus 200 is the “automatic transfer off” mode. Accordingly, even if a generation notification is received at time T611, the control unit 201 discards the generation notification rather than accepting it, and does not send the moving image file obtainment request at time T612a. Accordingly, the communication apparatus 200 cannot obtain the first chunk moving image file.

Assume that prior to time T616, the user performed an operation for transitioning to the shooting/automatic transfer screen 504 in the communication apparatus 200, and the operation mode of the communication apparatus 200 was switched to the “automatic transfer on” mode. In this case, in response to the generation notification being received at time T616, the control unit 201 sends a moving image file obtainment request at time T617a. Accordingly, the communication apparatus 200 can obtain the intermediate chunk moving image file. The communication apparatus 200 can also obtain the last chunk moving image file. As a result, the communication apparatus 200 cannot send some of the chunk moving image files to be combined to the server 300, but still sends the remaining chunk moving image files to the server 300.

The following will describe a configuration for suppressing occurrence of such a situation. The following descriptions assume that upon receiving a moving image recording start operation, the image capturing apparatus 100 sends a notification indicating that moving image recording has started (a moving image recording start notification) to the communication apparatus 200.

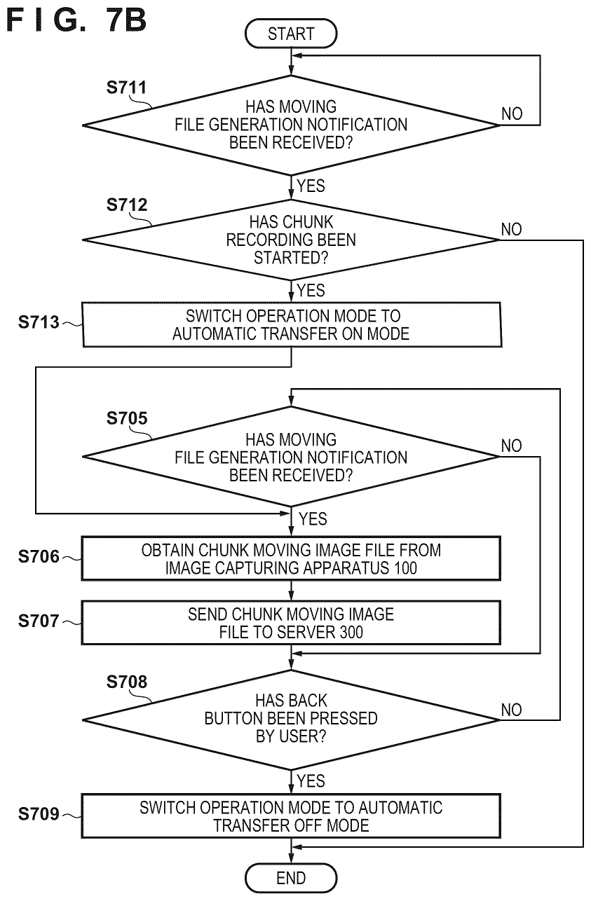

FIG. 7A is a flowchart illustrating shooting automatic transfer processing that involves automatically switching the operation mode, executed by the communication apparatus 200. Unless otherwise specified, the processes in the respective steps of the flowchart are realized by the control unit 201 executing a program stored in the non-volatile memory 203. The processing of the flowchart starts when the communication apparatus 200 is connected to the image capturing apparatus 100 while the function selection screen 501 is displayed in the display unit 206 (i.e., while the operation mode is the “automatic transfer off” mode).

In step S701, the control unit 201 determines whether a moving image recording start notification has been received from the image capturing apparatus 100. The control unit 201 repeats the determination of step S701 until a moving image recording start notification is received. Once a moving image recording start notification is received, the control unit 201 moves the sequence to step S702.

In step S702, the control unit 201 obtains a recording state of the image capturing apparatus 100 by sending a recording state obtainment request to the image capturing apparatus 100. Here, the “recording state” includes information (second information) indicating whether the moving image recording operation performed by the image capturing apparatus 100 is chunk recording (a first recording operation) or proxy recording (a second recording operation).

In step S703, on the basis of the obtained information of the recording state (the second information), the control unit 201 determines whether the image capturing apparatus 100 has started chunk recording. If the image capturing apparatus 100 is currently performing chunk recording, the control unit 201 moves the sequence to step S704. However, if the image capturing apparatus 100 is not currently performing chunk recording, the processing of this flowchart ends. In this case, even if a generation notification is received, the control unit 201 discards the generation notification and does not obtain the moving image file.

In step S704, the control unit 201 displays the shooting/automatic transfer screen 504, and switches the operation mode to the “automatic transfer on” mode.

In step S705, the control unit 201 determines whether a moving image file generation notification has been received from the image capturing apparatus 100. The control unit 201 moves the sequence to step S706 if a moving image file generation notification has been received, and to step S708 if not.

In step S706, the control unit 201 obtains a chunk moving image file corresponding to the generation notification by sending a moving image file obtainment request to the image capturing apparatus 100.

In step S707, the control unit 201 sends the chunk moving image file obtained from the image capturing apparatus 100 to the server 300.

In step S708, the control unit 201 determines whether the back button 505 provided in the shooting/automatic transfer screen 504 has been pressed by the user. If the back button 505 has not been pressed, the control unit 201 returns the sequence to step S705. However, if the back button 505 has been pressed, the control unit 201 moves the sequence to step S709.

In step S709, the control unit 201 switches the operation mode to the “automatic transfer off” mode, and displays the function selection screen 501 in the display unit 206.

Through the above-described processing illustrated in FIG. 7A, the control unit 201 switches the operation mode to the “automatic transfer on” mode in response to the start of chunk recording in the image capturing apparatus 100 being detected while the function selection screen 501 is displayed (i.e., while the operation mode is the “automatic transfer off” mode). Doing so reduces the likelihood of obtaining an intermediate chunk moving image file without obtaining the first chunk moving image file. Accordingly, situations where some of the chunk moving image files to be combined have not yet been transferred to the server 300, but the remaining chunk moving image files are nevertheless transferred to the server 300, can be suppressed.

The foregoing described the control unit 201 as determining whether the operation mode is to be switched to the “automatic transfer on” mode on the basis of information about the recording state. However, the control unit 201 may determine whether to switch the operation mode to the automatic transfer on mode also taking into account whether information required for the transfer (e.g., a server name (identification information) of the server 300, a folder name, and the like to which the files are to be transferred) is set. Even in chunk recording, if the information required for the transfer is not set, the control unit 201 may keep the operation mode in the “automatic transfer off” mode without displaying the shooting/automatic transfer screen 504.

The communication apparatus 200 is configured to display a menu screen for setting the information required for the transfer, such as the identification information of the server 300. The control unit 201 sets the information required for the transfer, such as the identification information of the server 300, in accordance with an operation performed by the user in the menu screen. In this case, in step S707, the control unit 201 sends the chunk moving image files to the server identified by the set identification information.

To prevent the user from unintentionally starting the shooting/automatic transfer, the control unit 201 may display a screen for causing the user to select whether to switch the operation mode to the “automatic transfer on” mode.

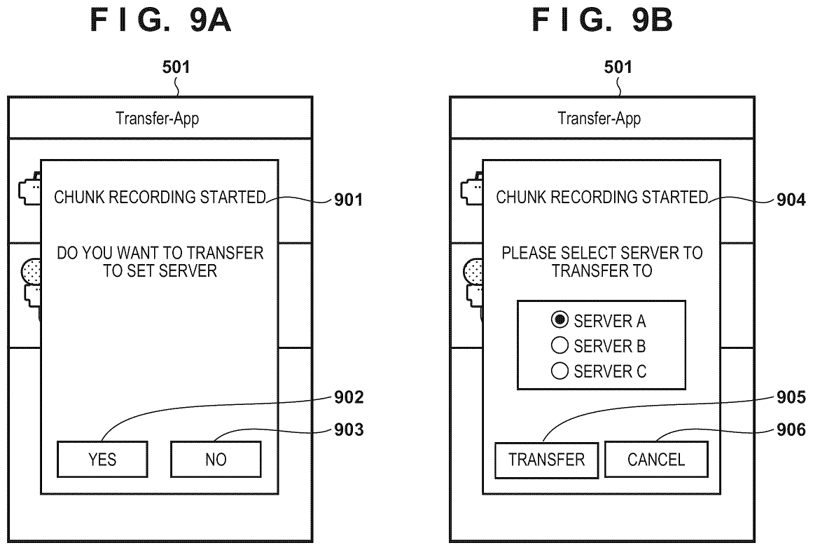

FIG. 9A is a diagrams illustrating an example of a screen for causing the user to select whether to switch the operation mode to the “automatic transfer on” mode. When a determination of “YES” is made in step S703, the control unit 201 displays a screen 901 such as that illustrated in FIG. 9A. The screen 901 includes a message confirming whether to start the shooting/automatic transfer. If the user presses a “yes” button 902, the control unit 201 moves the sequence to step S704, and switches the operation mode to the “automatic transfer on” mode. However, if the user presses a “no” button 903, the control unit 201 keeps the operation mode in the “automatic transfer off” mode, and ends the processing in FIG. 7A.

FIG. 9B is a diagrams illustrating another example of a screen for causing the user to select whether to switch the operation mode to the “automatic transfer on” mode. When a determination of “YES” is made in step S703, the control unit 201 displays a screen 904 such as that illustrated in FIG. 9B. The screen 904 includes a message for the selection of the transfer destination server, and the user can select a desired server. Accordingly, the example illustrated in FIG. 9B also makes it possible to prevent transfers to a server not intended by the user. When the user selects the desired server and presses a “transfer” button 905, the control unit 201 moves the sequence to step S704, and switches the operation mode to the “automatic transfer on” mode. However, if the user presses a “cancel” button 906, the control unit 201 keeps the operation mode in the “automatic transfer off” mode, and ends the processing in FIG. 7A.

An item for selecting whether to turn the automatic start of the shooting/automatic transfer on or off may also be provided in a settings menu of the communication apparatus 200. If, when automatic start is set to on, a determination of “YES” is made in step S703, the control unit 201 moves the sequence to step S704, and switches the operation mode to the “automatic transfer on” mode. If automatic start is set to off, the control unit 201 does not perform the processing illustrated in FIG. 7A. The operation mode therefore stays in the “automatic transfer off” mode even if chunk recording is started.

### Processing Sequence Corresponding to FIG. 7A

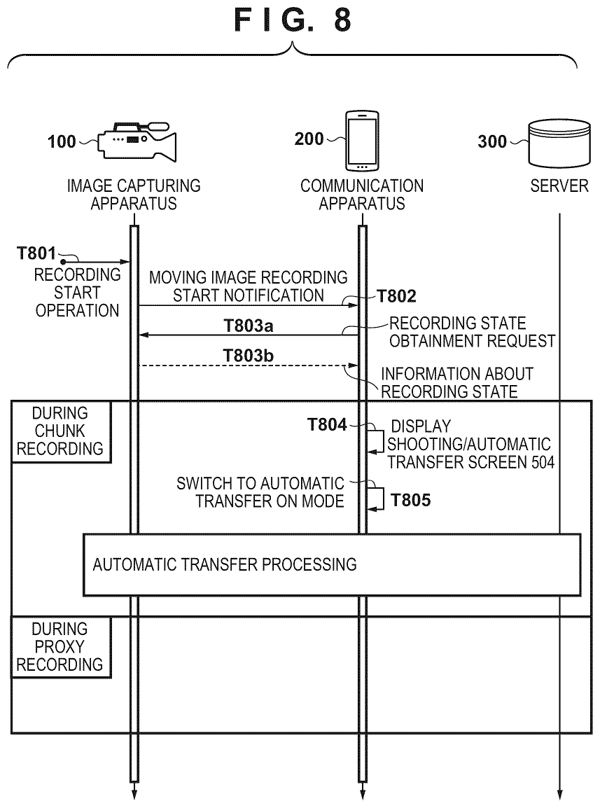

FIG. 8 is a diagram illustrating a sequence of processing performed in shooting automatic transfer when the communication apparatus 200 performs the processing illustrated in FIG. 7A.

At time T801, the control unit 101 of the image capturing apparatus 100 receives a recording start operation from the user through the operation unit 105.

At time T802, the control unit 101 sends a moving image recording start notification to the communication apparatus 200. The control unit 201 of the communication apparatus 200 receives the moving image recording start notification.

At time T803a, the control unit 201 sends a recording state obtainment request to the image capturing apparatus 100. The control unit 101 receives the recording state obtainment request.

At time T803b, the control unit 101 sends information about the recording state, including information indicating whether the moving image recording operation is chunk recording (the first recording operation) or proxy recording (the second recording operation) (i.e., the second information), to the communication apparatus 200. The processing by the control unit 201 at times T803a and T803b corresponds to step S702 in FIG. 7A.

If the recording operation is chunk recording, the control unit 201 displays the shooting/automatic transfer screen 504 at time T804.

At time T805, the control unit 201 switches the operation mode to the “automatic transfer on” mode. The processing by the control unit 201 at times T804 and T805 corresponds to step S704 in FIG. 7A. The image capturing apparatus 100 performs the same processing as that of time T608 in FIG. 6B-1 in parallel with this processing.

The same processing as that performed at times T609 to T624 in FIGS. 6B-1 and 6B-2 is then performed. The processing by the control unit 201 here corresponds to steps S705 to S708 in FIG. 7A.

If the recording operation is proxy recording, the control unit 101 of the image capturing apparatus 100 performs the same processing as that performed at times T602 to T604 in FIG. 6A. However, the received generation notification is discarded, and the control unit 201 of the communication apparatus 200 therefore does not obtain the moving image file.

### Variation on FIG. 7A

FIG. 7A illustrates the control unit 201 determining whether the operation mode is to be switched to the “automatic transfer on” mode on the basis of information about the recording state obtained from the image capturing apparatus 100. However, the method for determining whether to switch the operation mode to the “automatic transfer on” mode is not limited to the method illustrated in FIG. 7A.

FIG. 7B is a flowchart illustrating a variation on the processing illustrated in FIG. 7A. In this variation, the image capturing apparatus 100 does not need to send a moving image recording start notification.

In step S711, the control unit 201 determines whether a moving image file generation notification has been received from the image capturing apparatus 100. The control unit 201 repeats the determination of step S711 until a generation notification is received. Once a generation notification is received, the control unit 201 moves the sequence to step S712.

In step S712, the control unit 201 determines, on the basis of the generation notification, whether the image capturing apparatus 100 has started chunk recording. As described above, the generation notification includes the filename of the moving image file, and if the moving image file is the first chunk moving image file, the fourth character of the filename is “B”. In other words, the first generation notification sent after the start of chunk recording (the first recording operation) includes information (first information) indicating that the image capturing apparatus 100 has started chunk recording, and this information is included in the filename included in the generation notification, for example. The control unit 201 can detect that the chunk recording has started in response to receiving a generation notification including a filename that includes “B” as the fourth character. The control unit 201 moves the sequence to step S713 if chunk recording has started, and ends the processing of the flowchart if not (if the fourth character of the filename is “P”).

The processing of step S713 is the same as that of step S704 in FIG. 7A. However, in FIG. 7B, the first generation notification has already been received, and thus the control unit 201 moves the sequence from step S713 to step S706. The subsequent processing is the same as that in FIG. 7A.

### Summary of First Embodiment

As described above, according to the present embodiment, the communication apparatus 200 is configured to communicate with the image capturing apparatus 100, which is capable of executing chunk recording (the first recording operation) in which a moving image is divided into a plurality of moving image files and recorded. When the operation mode of the communication apparatus 200 is the “automatic transfer on” mode (the first operation mode), the communication apparatus 200 executes obtainment control in which each time a new moving image file is generated in the image capturing apparatus 100, the new moving image file is obtained (e.g., times T611 to T623b in FIGS. 6B-1 and 6B-2, steps S705 to S708 in FIGS. 7A and 7B, and the like). However, when the operation mode is the “automatic transfer off” mode (the second operation mode), the communication apparatus 200 does not execute the obtainment control. The communication apparatus 200 detects the image capturing apparatus 100 starting chunk recording (the first recording operation) (e.g., step S703 in FIG. 7A and step S712 in FIG. 7B). The communication apparatus 200 switches the operation mode to the “automatic transfer on” mode (the first operation mode) in response to the start of chunk recording (the first recording operation) being detected while the operation mode is the “automatic transfer off” mode (the second operation mode) (e.g., steps S703 to S704 in FIG. 7A and steps S712 to S713 in FIG. 7B).

Therefore, according to the present embodiment, when the image capturing apparatus divides a moving image into a plurality of moving image files and records the files, the likelihood of the communication apparatus obtaining only some of the plurality of moving image files from the image capturing apparatus can be reduced.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-069198, filed Apr. 22, 2024, which is hereby incorporated by reference herein in its entirety.

What is claimed is:

1. A communication apparatus configured to communicate with an image capturing apparatus capable of executing a first recording operation in which a moving image is divided into a plurality of moving image files and recorded, the communication apparatus comprising:
a control unit configured to, in a case where an operation mode of the communication apparatus is a first operation mode, execute obtainment control in which each time a new moving image file is generated in the image capturing apparatus, the new moving image file is obtained from the image capturing apparatus, and in a case where the operation mode is a second operation mode, skip executing the obtainment control;
a detection unit configured to detect the image capturing apparatus starting the first recording operation; and
a switching unit configured to switch the operation mode to the first operation mode in response to a start of the first recording operation being detected while the operation mode is the second operation mode.

2. The communication apparatus according to claim 1,
wherein the image capturing apparatus is configured to send, to the communication apparatus, a generation notification indicating that a new moving image file has been generated, each time the new moving image file is generated, and
in the obtainment control, the control unit obtains the new moving image file corresponding to the generation notification from the image capturing apparatus each time the generation notification is received from the image capturing apparatus.

3. The communication apparatus according to claim 2,
wherein the generation notification first sent by the image capturing apparatus after the start of the first recording operation includes first information indicating that the image capturing apparatus has started the first recording operation, and
the detection unit detects the image capturing apparatus starting the first recording operation in response to the generation notification including the first information being received from the image capturing apparatus.

4. The communication apparatus according to claim 3,
wherein the generation notification includes a filename of the new moving image file corresponding to the generation notification, and
the first information is included in the filename included in the generation notification first sent after the start of the first recording operation.

5. The communication apparatus according to claim 1,
wherein the switching unit switches the operation mode between the first operation mode and the second operation mode in accordance with a user instruction.

6. The communication apparatus according to claim 1,
wherein as a recording operation for the moving image, the image capturing apparatus is capable of selectively executing (i) the first recording operation or (ii) a second recording operation of recording the moving image in a single moving image file, and
regardless of whether the recording operation is the first recording operation or the second recording operation, the control unit executes the obtainment control in a case where the operation mode is the first operation mode, and skips executing the obtainment control in a case where the operation mode is the second operation mode.

7. The communication apparatus according to claim 6,
wherein the detection unit detects the image capturing apparatus starting the second recording operation, and
in a case where a start of the second recording operation is detected while the operation mode is the second operation mode, the switching unit skips switching the operation mode to the first operation mode.

8. The communication apparatus according to claim 1,
wherein as a recording operation for the moving image, the image capturing apparatus is capable of selectively executing (i) the first recording operation or (ii) a second recording operation of recording the moving image in a single moving image file, and
the detection unit:
detects the image capturing apparatus starting the recording operation;
obtains, from the image capturing apparatus, second information indicating whether the recording operation is the first recording operation or the second recording operation, in response to a start of the recording operation being detected; and
detects the image capturing apparatus starting the first recording operation or the image capturing apparatus starting the second recording operation on a basis of the second information.

9. The communication apparatus according to claim 1, further comprising:
a display unit configured to display a screen for causing a user to select whether or not to switch the operation mode to the first operation mode in response to the start of the first recording operation being detected while the operation mode is the second operation mode.

10. The communication apparatus according to claim 1, further comprising:
a sending unit configured to send the moving image file obtained through the obtainment control to a server.

11. The communication apparatus according to claim 1, further comprising:
a setting unit configured to set identification information of a server; and
a sending unit configured to send the moving image file obtained through the obtainment control to the server identified by the identification information,
wherein in a case where the identification information is not set, the switching unit skips switching the operation mode to the first operation mode, even in a case where the start of the first recording operation is detected while the operation mode is the second operation mode.

12. A control method executed by a communication apparatus configured to communicate with an image capturing apparatus capable of executing a first recording operation in which a moving image is divided into a plurality of moving image files and recorded, the control method comprising:
in a case where an operation mode of the communication apparatus is a first operation mode, executing obtainment control in which each time a new moving image file is generated in the image capturing apparatus, the new moving image file is obtained from the image capturing apparatus, and in a case where the operation mode is a second operation mode, skipping executing the obtainment control;
detecting the image capturing apparatus starting the first recording operation; and
switching the operation mode to the first operation mode in response to a start of the first recording operation being detected while the operation mode is the second operation mode.

13. A non-transitory computer-readable storage medium which stores a program for causing a computer of a communication apparatus to execute a control method, the communication apparatus being configured to communicate with an image capturing apparatus capable of executing a first recording operation in which a moving image is divided into a plurality of moving image files and recorded, the control method comprising:
in a case where an operation mode of the communication apparatus is a first operation mode, executing obtainment control in which each time a new moving image file is generated in the image capturing apparatus, the new moving image file is obtained from the image capturing apparatus, and in a case where the operation mode is a second operation mode, skipping executing the obtainment control;
detecting the image capturing apparatus starting the first recording operation; and
switching the operation mode to the first operation mode in response to a start of the first recording operation being detected while the operation mode is the second operation mode.
